(19) United States
(12) Patent Application Publication
(10) Pub. No.: US 2006/0188668 A1
(43) Pub. Date: Aug. 24, 2006

(54) Decorative attachment for personal property

(76) Inventor: Sol Wahba, Brooklyn, NY (US)

Correspondence Address: KAPLAN GILMAN GIBSON & DERNIER L.L.P., 900 ROUTE 9 NORTH, WOODBRIDGE, NJ, 07095, US

(21) Appl. No.: 11/062,096

(22) Filed: Feb. 18, 2005

(51) Int. Cl. B44C 5/00; B32B 33/00; A47G 35/00

(52) U.S. Cl. 428/13; 428/40.4; 428/542.2; 428/542.6

(57) ABSTRACT

A device is disclosed which includes a sheet suitable for attachment to an article of personal property; and a plurality of decorative elements disposed on a first surface of the sheet, said decorative elements displaying a pattern on said device. A method is disclosed which includes providing a decorative device having a sheet, the sheet having a first surface and a second surface, the first surface having a plurality of decorative elements disposed thereon, the plurality of decorative elements displaying a pattern; providing an article of personal property; and securing the decorative device to a surface of the article.

### BACKGROUND OF THE INVENTION

Consumers have expressed an interest in decorating various articles of personal property with various symbols, letters, characters, numbers, and the like. These articles include portable electronic devices, such as cell phones, portable audio and audio/video devices, portable computers, among other products.

Existing approaches to such decoration usually involve the acquisition of decorative elements, such as crystals, and glue and then manually affixing the decorative elements to an article to be decorated. This approach may produce a decorative effect that approaches the desired result but includes many drawbacks. The manual approach is time consuming for a consumer at any skill level, but particularly so for a consumer who is not experienced at forming the desired decorative arrangement. Moreover, during what is likely to be a process of trial and error for most consumers, some number of decorative elements may be rendered unusable, thereby wasting these elements. Furthermore, some amount of glue may be misplaced both causing waste and unintentionally spilling glue onto surfaces that require a time-consuming cleanup after the work is complete.

In addition to the inefficiency of the existing approach, the quality of the result obtained using the existing approach will depend heavily on the experience and skill of the person applying the pattern of decorative elements. In some cases, the resulting patterns may have poor geometric consistency and be unsightly, thereby defeating the decorative purpose the entire process is intended to accomplish. Moreover, in other cases, a mistake may be difficult to correct since once the glue dries, removal of improperly located decorative elements may be difficult to achieve and/or may damage the decorative elements and/or the article of personal property being decorated. Accordingly, there is a need in the art for an improved apparatus and method for decorating articles of personal property.

### SUMMARY OF THE INVENTION

According to one aspect, the invention provides a device, comprising: a sheet suitable for attachment to an article of personal property; and a plurality of decorative elements disposed on a first surface of the sheet, the decorative elements displaying a pattern on the device.

According to another aspect, the invention provides an apparatus comprising: a container; a plurality of decorative devices disposed within the container, each decorative device comprising a sheet having first and second surfaces, the second surface having an adhesive layer affixed thereto and being connected via the adhesive surface to a backing layer, the first surface having a plurality of decorative elements disposed thereon, the decorative elements displaying a pattern on the first surface, the decorative devices being suitable for affixation to one or more articles of personal property; and a mechanism for closing the container.

According to yet another aspect, the invention provides a method, comprising: providing a decorative device having a sheet, the sheet having a first surface and a second surface, the first surface having a plurality of decorative elements disposed thereon, the plurality of decorative elements displaying a pattern; providing an article of personal property; and securing the decorative device to a surface of the article.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a plan view of a decorative device connected to a backing layer in accordance with one or more embodiments of the present invention;

FIG. 2 is a plan view of a plurality of decorative devices connected to a backing layer in accordance with one or more embodiments of the present invention;

FIG. 3 is a plan view of a decorative device connected to a backing layer in accordance with one or more embodiments of the present invention;

FIG. 4 is a plan view of a decorative device attached to a backing layer, there being a variation in cosmetic characteristics among the decorative elements disposed on the decorative device in accordance with one or more embodiments of the present invention;

FIG. 5 is a plan view of a decorative device attached to a backing layer showing a star pattern using a variation in cosmetic characteristics of decorative elements disposed on the decorative device in accordance with one or more embodiments of the present invention;

FIG. 5A is a cross-sectional view of the decorative device and backing layer taken along the line 5A in FIG. 5;

FIG. 6 is a perspective view of a plurality of decorative devices attached to a cell phone in accordance with one or more embodiments of the present invention;

FIG. 7 is a perspective view of a plurality of decorative devices attached to a cell phone in accordance with one or more embodiments of the present invention;

FIG. 8 is a perspective view of a plurality of decorative devices attached to a portable electronic audio device in accordance with one or more embodiments of the present invention;

FIG. 9 is a perspective view of a kit of decorative devices incorporated within commercial packaging in accordance with one or more embodiments of the present invention;

FIGS. 10-12 are plan views of groups of decorative devices which could be included in kits, such as the kit of FIG. 9, in accordance with one or more embodiments of the present invention;

FIG. 13 is a plan view of a decorative device incorporating a pattern of a leopard hide in accordance with one or more embodiments of the present invention;

FIG. 14 is a plan view of a decorative device incorporating a pattern of a zebra hide in accordance with one or more embodiments of the present invention; and

FIG. 15 is a plan view of a decorative device incorporating a pattern of a tiger hide in accordance with one or more embodiments of the present invention.

### DETAILED DESCRIPTION OF THE PREFERRED EMBODIMENTS

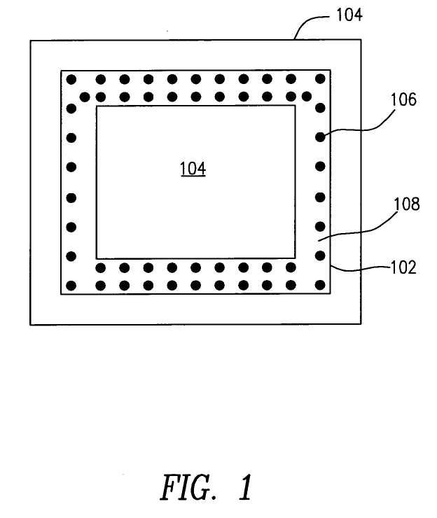

Herein, the term “pattern” includes all images illustrated by decorative elements disposed on decorative devices in FIGS. 1-8, thereby including but not limited to heart shapes, rectangles, single-element-wide rows of decorative elements, arc-shaped rows of decorative elements, and alphanumeric characters.

With reference to the drawings, wherein like numerals indicate like elements, there is shown in FIG. 1 a plan view of a decorative device 102 connected to a backing layer 104 in accordance with one or more embodiments of the present invention. Decorative device 102 may be affixed to backing layer 106 via the use of an adhesive layer (not shown). However, means of attachment other than adhesive material may be used for attachment of attachment device 102 to an article of personal property. These alternative means may include but are not limited to magnetic force, clips, force fit, suction, and static electricity.

The pattern displayed by the arrangement of decorative elements 106 may be implemented in various ways. The decorative elements may substantially fill the available space on sheet 108 of decorative device 102. In this case, the shape of sheet 108 and thus of decorative device 102 will substantially determine the pattern displayed by the totality of decorative elements 106. As is discussed in connection with other FIGS below, a pattern displayed by decorative elements 106 may also be implemented based on a pattern of placement of decorative elements 106 on sheet 108 and/or by color variation among the decorative elements located on sheet 108 of decorative device 102.

In the embodiment of FIG. 1, decorative elements 106 can substantially fill the space on the upper surface of sheet 108 of decorative device 102. In this embodiment, decorative device 102 has a rectangular outer perimeter and a rectangular cutout in the center, which accounts for a portion of backing layer 104 being visible near the center of decorative device 102.

A wide range of shapes could be selected for decorative device 102. Moreover, shapes for decorative device 102 could be selected to match the shapes of surfaces of specific commercial products on which it is desired to locate decorative device 102. Moreover, the decorative elements 106 may be of similar size and shape, or the sizes and shapes of decorative elements 106 may vary within one of the decorative devices disclosed herein.

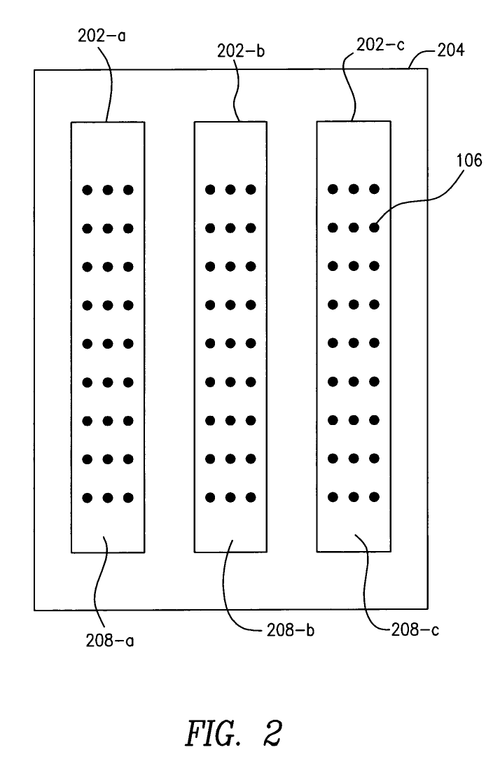

FIG. 2 is a plan view of a plurality of decorative devices 202-a, 202-b and 202-c connected to backing layer 204 in accordance with one or more embodiments of the present invention. In this embodiment, three separate decorative devices 202 a-c are initially located on a single backing layer 204. Thus, as usual, the individual decorative devices 202 can remain intact as a user transfers one or more of them from backing layer 204 to the surface of a product or article. However, upon removing decorative devices 202 a-c from backing layer 204, a user can re-arrange the relative placement of one or more of the decorative devices, as desired, on a surface of a personal article to obtain a desired pattern. It will be appreciated that any number of decorative devices 102 could be employed. Moreover, decorative devices 102 of different shapes could be located on a common backing layer 204.

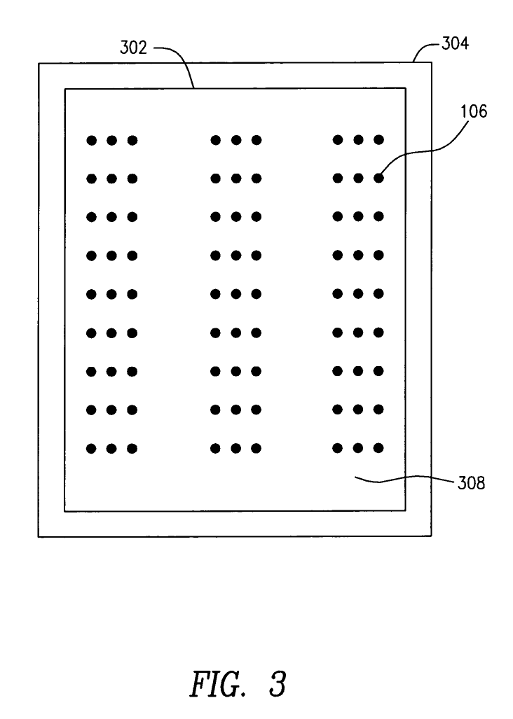

FIG. 3 is a plan view of a decorative device 302 connected to backing layer 304 in accordance with one or more embodiments of the present invention. In the embodiment of FIG. 3, the displayed pattern of decorative elements 106 arises from the distribution of decorative elements on sheet 308 of decorative device 302. Thus, in comparison with the embodiment of FIG. 2, less work is needed to reproduce the series of three rectangular distributions of decorative elements 106 on an article using the embodiment of FIG. 3. At the same time, the embodiment of FIG. 2 provides the user with greater flexibility in arranging the three separate decorative devices 202 a-c.

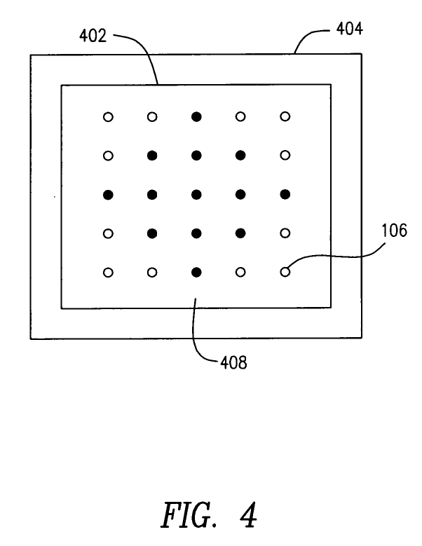

FIG. 4 is a plan view of a decorative device 402 attached to a backing layer 404, there being a variation in cosmetic characteristics among the decorative elements 106 disposed on decorative device 402 in accordance with one or more embodiments of the present invention. In the embodiment of FIG. 4, decorative device 402 can include sheet 408 on which decorative elements 106 may be placed. In this embodiment, a visible pattern may be implemented by varying one or more cosmetic characteristics of the various decorative elements 106.

In FIG. 4, for the sake of convenience, the illustration of cosmetic variation among the decorative elements 106 is shown by illustrating some decorative elements 106 with solid circles and other decorative elements 106 with hollow circles. However, cosmetic variation among decorative elements 106 in actual physical embodiments of decorative device 402 can be implemented by various means, such as by varying the color of decorative elements located on sheet 408 of decorative device 402. Other characteristics of decorative elements 106 which may be varied to implement a visible pattern include, but are not limited to, the shape and/or size of the decorative elements 106, the spacing between neighboring elements, the reflectivity of the elements, and/or the degree of transparency of each element 106.

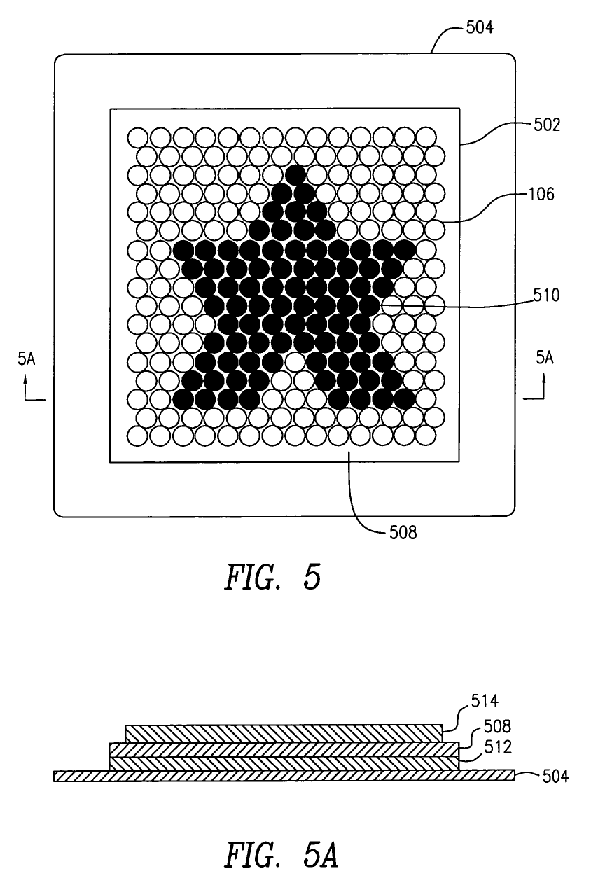

FIG. 5 is a plan view of decorative device 502 attached to backing layer 504 showing a star pattern 510 using a variation in cosmetic characteristics of decorative elements 106 disposed on decorative device 502 in accordance with one or more embodiments of the present invention. FIG. 5 illustrates a concept similar to that shown in FIG. 4 except that FIG. 5 illustrates a star-shaped pattern. It will apparent to those of skill in the art that patterns of any shape and that any total number of patterns may be illustrated within one decorative device 502 using the principles disclosed herein.

FIG. 5A is a sectional view of the decorative device and backing layer of FIG. 5. In this embodiment, backing layer 504 is shown at the bottom. Adhesive layer 512 of decorative device 502 is shown above backing layer 504. Sheet 508 of decorative device 502 is shown above adhesive layer 512. Finally, a layer 514 of decorative elements 106 is shown on sheet 508. While the embodiment of FIG. 5A shows an adhesive layer, it will be appreciated that the present invention is not limited to the use of an adhesive layer. As previously discussed, other means including magnetism, clips, suction, clamps, force fit, static electricity, or other mechanisms may be employed to locate decorative device 502 on an article of property of a user's choice.

In one embodiment, decorative elements 106 may be pieces of plastic and/or glass having a plurality of substantially flat surfaces for reflecting light in a decorative and desirable manner. In one embodiment, decorative elements 106 can have a diameter of about 0.1 inches, although decorative elements larger or smaller than this may be used. In one embodiment, decorative elements 106 can be generally spherical and have generally flat surfaces disposed about a periphery of the generally spherical shape, thereby emulating the appearance of a precious gem. Moreover, decorative elements 106 could be three-dimensional polygons of any size and having a wide range of possible shapes. Moreover, decorative elements 106 are not limited to any particular shape, to any particular size, or to being made of any particular material.

Decorative elements 106 may be made of inexpensive materials, such as plastic or glass. Alternatively, decorative elements 106 may include items of greater value, such as gems, if desired. Decorative elements 106 could also include pieces of metal or other material which could be located on the surface of sheet 508 of decorative device 502 or within sheet 508. Moreover, decorative elements may be made of any material or combination of materials selected from a group that includes but is not limited to: crystal, glass, plastic, metal, wood, paper, leather, metal oxides, and ceramic.

In some embodiments, decorative elements 106 can be located on a surface of sheet 508 of decorative device 502 (or other embodiments of decorative devices 102, 202, 302, 402, etc). Alternatively, decorative elements 106 could be embedded within a layer of material forming part of sheet 508 of decorative device 502. In still other embodiments, decorative elements 106 could be located on a lower surface of sheet 508.

Items which decorative devices (102, 202, 302, 402, and/or 502) may be placed on include but are not limited to: cell phones, portable digital audio devices, computers including portable computers, cameras, cosmetic supply containers, sunglasses, toothbrushes, remote control devices, address books, ceramics, combs, mirrors, watches, pill boxes, flower pots, picture frames, hairbrushes, hair accessories, handbags, calculators, shoes, hats, shirts, pants, and other articles of clothing, wine glasses, chests and other containers of personal goods, joysticks, telephones, microphones, clocks, household thermometers and humidifiers, pens and pencils and other writing instruments, hair clips, watches, remote control devices for home audio and video devices, toys, dolls, figurines, tape dispensers, staplers and other home office products, scissors, candle holders, lamps such as lava-lamps, other household products, and other electronic products, whether portable or not.

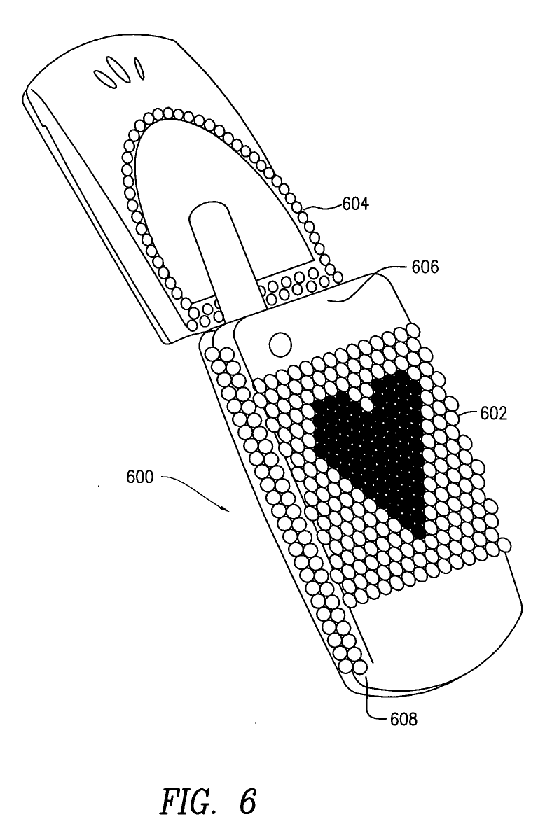

FIG. 6 is a perspective view 600 of a plurality of decorative devices attached to a cell phone in accordance with one or more embodiments of the present invention. It is noted that in the embodiment of FIG. 6, the shape and size of decorative device 602 substantially matches the size and shape of the surface to which it is attached. Decorative device 602 could be manufactured to match the surface to which it is attached in FIG. 6. Alternatively, device 602 could be customized by a user to fit the surface of the cell phone of FIG. 6 or the surfaces of other articles. In the embodiment of FIG. 6, the pattern displayed in decorative device 602 is a heart. However, any pattern could be displayed by decorative device 602.

In the embodiment of FIG. 6, additional decorative devices 604, 606, and 608 are also shown. In this embodiment, decorative device 604 forms an arc composed of substantially spherical decorative elements substantially matching the shape of a display screen on the cell phone to which it is attached, the arc being coupled to a row of decorative elements at one end of the arc. Alternatively, the arc and row of decorative elements forming decorative device 604 could be provided by two or more separate decorative devices.

In the embodiment of FIG. 6, decorative device 606 includes a row of substantially spherical decorative elements, located alongside and substantially parallel to the straight-row portion of decorative device 604. In FIG. 6, decorative device 608 includes two substantially straight and substantially parallel rows of decorative elements located next to decorative device 602. In an alternative embodiment, two separate decorative devices could be employed to provide the two rows of decorative device 608. It will be appreciated that additional decorative devices could be added to the cell phone of FIG. 6, if desired.

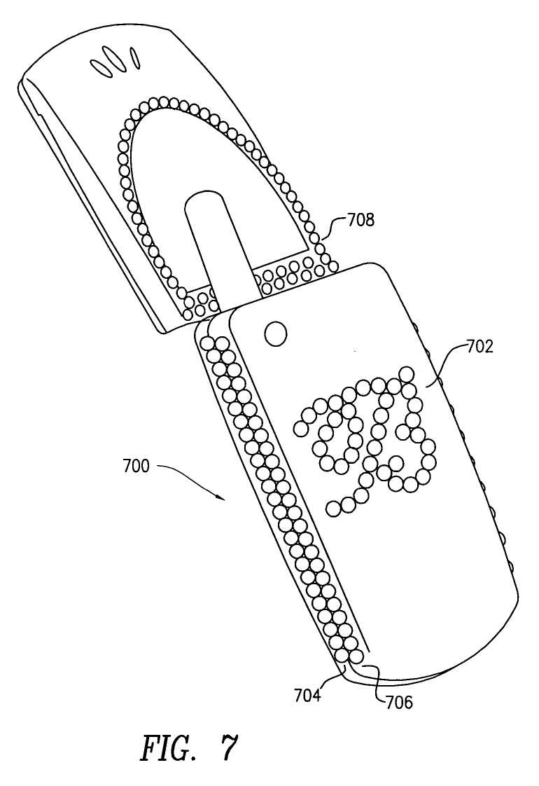

FIG. 7 is a perspective view 700 of a plurality of decorative devices 702, 704, 706, and 708 attached to a cell phone in accordance with one or more embodiments of the present invention. In this embodiment, decorative device 702 displays a script version of the letter “B.” Moreover, in this embodiment, the pattern of this letter is formed via the distribution of the decorative elements on device 702 rather than via color variation, or other cosmetic variation, among the decorative elements. It will be appreciated that any alphanumeric character or image or combination thereof could be represented employing the patterning method used in decorative device 702.

The embodiment of FIG. 7 also includes decorative devices 704, 706, and 708. In this embodiment, decorative devices 704 and 706 are substantially straight and substantially parallel rows of substantially circular decorative elements. In an alternative embodiment, the rows of decorative elements provided by decorative devices 704 and 706 could be provided by a single two-row decorative device.

The embodiment of FIG. 7 further includes decorative device 708 which includes one arc pattern of decorative elements and two substantially parallel rows of decorative elements. In an alternative embodiment, the arc and two rows of decorative elements included in decorative device 708 could be provided employing two or more separate decorative devices.

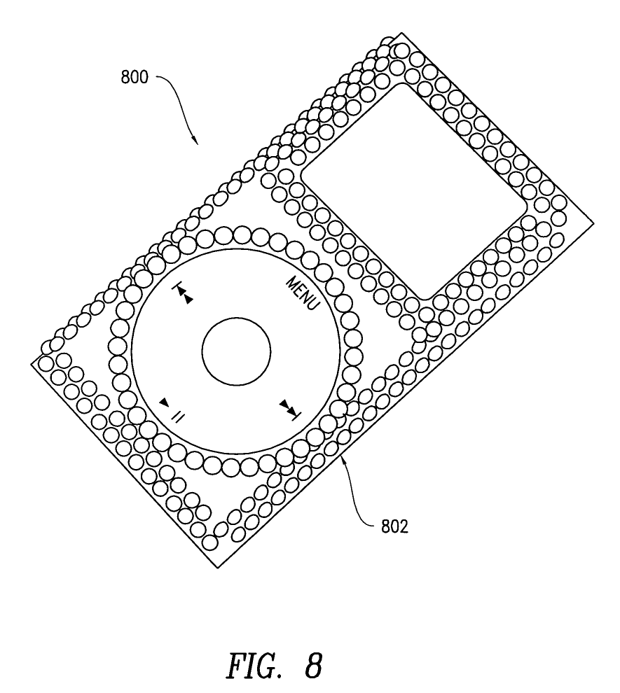

FIG. 8 is a perspective view 800 of a decoration 802 attached to the front surface of a portable electronic audio device in accordance with one or more embodiments of the present invention. Since decoration 802 includes a number of different geometric patterns (a circle and a plurality of rectangles), decoration 802 could be provided either with one decorative device incorporating all of the geometric patterns shown in FIG. 8 or with a plurality of decorative devices, each including one or more of the geometric patterns shown in FIG. 8.

In one or more embodiments of the present invention, the decorative devices disclosed herein can be removed from surfaces of articles of personal property to which they have been attached without causing damage either to the article or to the decorative device. In the case of articles of clothing, the decorative devices can be removed prior to washing clothes and then replaced on the clothing once washing and drying are complete. Thus, damage to the disclosed decorative devices from the effects of washing machines and dryers can be readily avoided. This contrasts with the situation faced when using existing forms of clothing decoration.

In the case of cell phones and other electronic products, the decorative devices disclosed herein can be removed without damaging the cell phone or other electronic product. This feature can help avoid problems, for instance, when returning the cell phone or other device to a retailer or manufacturer for refund, maintenance or repair.

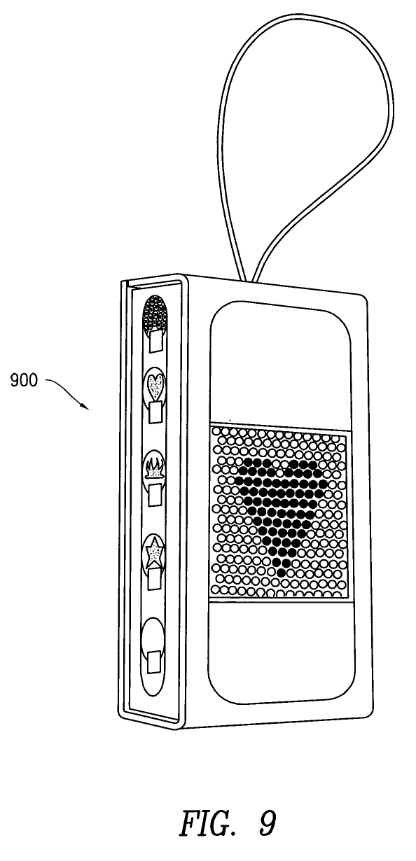

FIG. 9 is a perspective view of a kit 900 of decorative devices incorporated within commercial packaging in accordance with one or more embodiments of the present invention. Kit 900 can provide a user with a convenient assortment of decorative devices (such as, but not limited to, devices 102, 202, 302, 402, 502, 602, and 602) which devices can have different sizes and shapes and which can incorporate different patterns and/or characters thereon. The decorative devices included in kit 900 may be used as originally provided, or may be modified (by cutting to various shapes and sizes) as desired by a user. The decorative devices (not shown) can be used either individually, or in combination, to provide a desired result.

Different kits 900 may be made available with different ones of the kits having different combinations of decorative devices therein. Moreover, different kits may have different themes within which the included decorative devices fall. For instance, one exemplary kit could focus on alphabetic characters. This type of kit could enable a purchaser to construct a desired sequence of characters, customized to that purchaser's wishes. The sequence of characters could, for instance, correspond to a first name, a nickname, or a set of initials. In this embodiment, while the patterns representing the individual characters would be pre-arranged, the sequence of characters placed onto an article by a purchaser could be selected by the purchaser.

In another embodiment, kits of decorative devices could be tailored to decorate particular commercial products. For instance, kits could be customized to accommodate a selected Samsung® cell phone, Motorola® cell phone, I-pod®, Palm Pilot® and/or numerous other consumer products whether electronic or non-electronic, and whether portable or non-portable. While tailored for a particular product, these kits could include a wide variety of different decorative devices, with some devices illustrating images, others illustrating alphanumeric symbols and so forth.

More generally, the pre-arranged patterns could be standard or custom-made. Thus, some decorative devices could include patterns which are widely used and which are not specific to a particular purchaser or group of purchasers. However, other decorative devices could include patterns that are customized for specialized groups of customers or even for individual customers. For instance, letter sequences spelling out names such as “Jack” or “Susan” could be made available on selected decorative devices for purchasers wishing to acquire decorative devices with such names illustrated thereon as pre-arranged patterns.

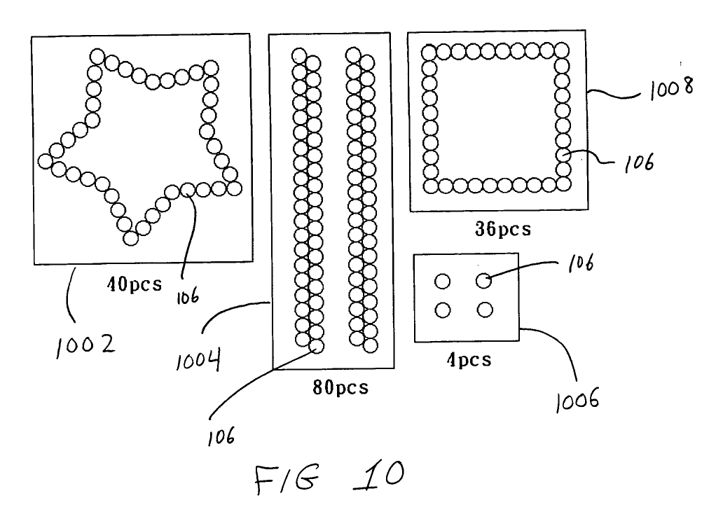

FIG. 10 illustrates a group of decorative devices which could be included in a kit, such as the kit of FIG. 9, in accordance with one or more embodiments of the present invention. In the embodiment of FIG. 10, a kit could include forty decorative devices 1002 illustrating a star-shaped pattern, eighty devices 1004 each device having two sets of closely spaced rows of decorative elements, four devices 1006 having decorative elements sparsely distributed within a “square” pattern and thirty-six devices 1008 having decorative elements closely spaced and forming the perimeter of a square. Clearly, the number and type of the devices that could be included in a kit could be varied extensively, and all such variations are intended to be included within the scope of the present invention. In one or more embodiments, the decorative devices of FIG. 10, which can be included within one kit of devices, are selected for their suitability for application to a particular article of personal property, such as a particular cell phone or particular hair care product.

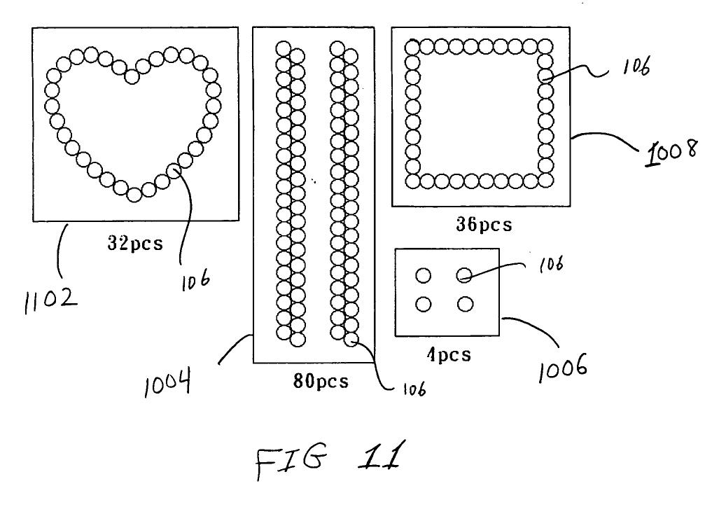

FIG. 11 illustrates a group of devices similar to those illustrated in FIG. 10 except that a group of thirty-two devices 1102 having heart-shaped patterns has been substituted for the group of forty devices 1002 having star-shaped patterns shown in FIG. 10. As with the embodiment of FIG. 10, the number and type of devices that could be included in a kit could be varied extensively, and all such variations are intended to be included within the scope of the present invention. In one or more embodiments, the decorative devices of FIG. 11, as with the devices of FIG. 10, can be selected for their suitability for application to a particular article of personal property and can all be included within one kit of devices.

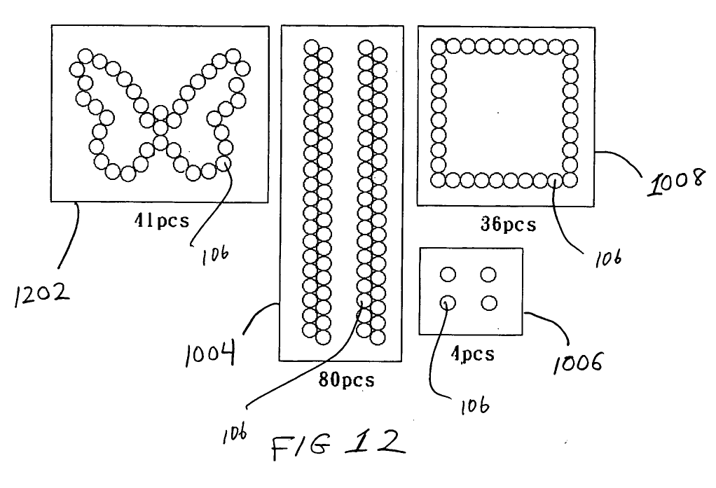

FIG. 12 illustrates a group of devices similar to those illustrated in FIG. 10 except that a group of forty-one devices 1202 having butterfly-shaped patterns has been substituted for the group of forty devices 1002 having star-shaped patterns shown in FIG. 10. As with the embodiment of FIG. 10, the number and type of devices that could be included in a kit could be varied extensively, and all such variations are intended to be included within the scope of the present invention. In one or more embodiments, the decorative devices of FIG. 12, as with the devices of FIGS. 10 and 11, can be selected for their suitability for application to a particular article of personal property and can all be included within one kit of devices.

In one or more embodiments, the decorative devices shown in FIGS. 1-8 and 10-12 are intended to be applied as inseparable units of decoration, without isolating the individual decorative elements 106 for independent attachment to articles of personal property. For example, decorative devices 1002, 1102, and 1202 including images of a star, a heart and a butterfly (FIGS. 10, 11 and 12), respectively, are intended to be applied as single units of decoration and not separated out into dozens of separately applied decorative elements 106. Moreover, in one or more embodiments, decorative devices 1004, which include rows of decorative elements 106, are also intended to be applied to articles as single units of decoration.

FIGS. 10-12 are plan views of groups of decorative devices which could be included in kits, such as the kit of FIG. 9, in accordance with one or more embodiments of the present invention;

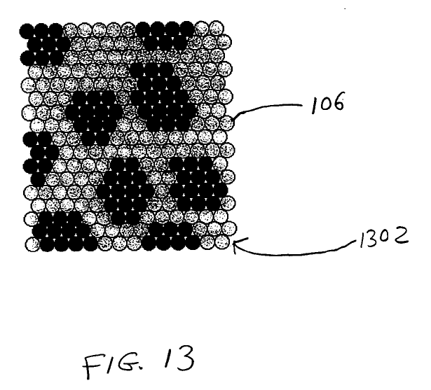

FIG. 13 is a plan view of a decorative device 1302 incorporating a pattern of a leopard hide in accordance with one or more embodiments of the present invention. In one embodiment, the colors of decorative elements 106 within device 1302 may be varied to implement the illustrated pattern.

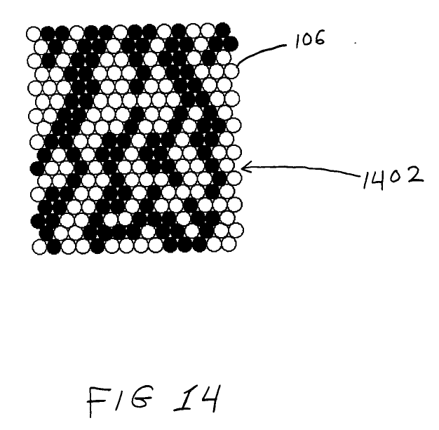

FIG. 14 is a plan view of a decorative device 1402 incorporating a pattern of a zebra hide in accordance with one or more embodiments of the present invention. In one embodiment, the colors of decorative elements 106 within device 1402 may be varied to implement the illustrated pattern.

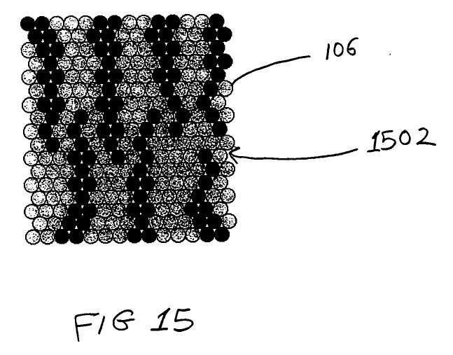

FIG. 15 is a plan view of a decorative device 1502 incorporating a pattern of a tiger hide in accordance with one or more embodiments of the present invention. In one embodiment, the colors of decorative elements 106 within device 1502 may be varied to implement the illustrated pattern.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims, and such alternatives are meant to be incorporated herein.

1. A device, comprising:
a sheet suitable for attachment to an article of personal property; and
a plurality of decorative elements disposed on a first surface of said sheet, said decorative elements displaying a pattern on said device, wherein said decorative elements include plastic.

2. The device of claim 1 further comprising:
means for attaching said device to said article of personal property.

3. The device of claim 2 wherein said device is removably attachable to said article.

4. The device of claim 2 wherein said device is removable from said article without causing damage to said article.

5. The device of claim 2 wherein said device is removable from said article without causing damage to said device.

6. The device of claim 2 wherein said means for attaching comprises an adhesive layer disposed on a second surface of said sheet.

7. The device of claim 2 wherein said means for attaching comprises:
a magnet disposed in said device.

8. The device of claim 2 wherein said means for attaching comprises:
Ferro-magnetic material disposed within said device.

9. (canceled)

10. The device of claim 1 wherein said sheet is attachable to said article of personal property via securing means disposed on said article of personal property.

11. (canceled)

12. The device of claim 1 wherein said decorative elements also include glass.

13. The device of claim 6 wherein said device is affixed to a backing layer employing said adhesive layer prior to being attached to said article of personal property.

14. The device of claim 1 wherein said article of personal property is an item selected from the group consisting of: a cell phone, an electronic audio device, a digital camera, a personal digital assistant, and a calculator.

15. The device of claim 1 wherein said article of personal property is a cell phone.

16. The device of claim 1 wherein said article of personal property is a hair accessory.

17. The device of claim 1 wherein said article of personal property is a pair of sunglasses.

18. The device of claim 1 wherein said article is an item selected from the group consisting of: a shoe, a shirt, a pair of pants, a hat, and a handbag.

19. The device of claim 1 wherein said pattern is heart-shaped.

20. The device of claim 1 wherein said pattern comprises a series of recurring sub-patterns.

21. The device of claim 1 wherein said pattern comprises an animal hide pattern, the animal hide pattern selected from the group consisting of: a tiger hide pattern, a leopard hide pattern, and a zebra hide pattern.

22. The device of claim 1 wherein said pattern comprises at least one alphanumeric character.

23. The device of claim 1 wherein said pattern comprises a monogram.

24. The device of claim 1 wherein said pattern is formed by attaching said decorative elements to a first portion of said first surface and omitting said decorative elements from a second portion of said first surface.

25. The device of claim 1 wherein said pattern is formed through a variation in color of said decorative elements.

26. The device of claim 1 wherein said pattern is formed via a variation in size among said decorative elements.

27. The device of claim 1 wherein said pattern is formed via a variation in height among said decorative elements.

28. The device of claim 1 wherein said pattern is determined by a shape of said sheet.

29. The device of claim 1 wherein said device has a shape substantially matching a shape of a surface of said article.

30. An apparatus comprising:
a container;
a plurality of decorative devices disposed within said container, each said decorative device comprising a sheet having first and second surfaces, said second surface having an adhesive layer affixed thereto and being connected via said adhesive surface to a backing layer, said first surface having a plurality of decorative elements disposed thereon, said decorative elements displaying a pattern on said first surface, said decorative devices being suitable for affixation to one or more articles of personal property; and
a mechanism for closing said container.

31. The apparatus of claim 30 wherein said plurality of decorative devices comprises:
a plurality of decorative devices having star-shaped patterns illustrated thereon.

32. The apparatus of claim 30 wherein said plurality of decorative devices comprises a plurality of decorative devices having a common pattern displayed thereon, said common pattern selected from the group consisting of: a star-shaped pattern, a heart-shaped pattern, and a butterfly-shaped pattern.

33. A method, comprising:
providing a decorative device having a sheet, said sheet having a first surface and a second surface, said first surface having a plurality of decorative elements disposed thereon, said plurality of decorative elements displaying a pattern;
providing an article of personal property; and
securing said decorative device to a surface of said article.

34. The method of claim 33 further comprising:
removing said decorative device from said surface of said article without damaging said article.

35. The method of claim 34 further comprising:
conducting said removing without damaging said decorative device.

36. The method of claim 33 wherein said securing comprises:
removing a backing layer from said second surface of said sheet, thereby uncovering an adhesive layer on said second surface; and
securing said decorative device to said surface of said article employing said adhesive layer.

37. The method of claim 36 wherein said decorative device is removable from said article without damaging said article.

38. The device of claim 33 wherein said securing comprises:
inserting said decorative device into a slot in said article of personal property.

39. The device of claim 33 wherein said securing comprises:
securing said decorative device to said article employing at least one magnet.

40. The device of claim 33 wherein said securing comprises securing said decorative device to said article with at least one clip.

41. The device of claim 33 wherein said securing comprises force fitting said decorative device onto said article of personal property.

42. A device, comprising:
a sheet suitable for attachment to an article of personal property;
a plurality of plastic decorative elements disposed on a first surface of said sheet; and
an adhesive layer disposed over substantially all of a second surface of said sheet.

43. The device of claim 42 wherein said plurality of decorative elements includes a plurality of rows of said decorative elements on said first surface of said sheet.
